(19) United States
(12) Patent Application Publication
(10) Pub. No.: US 2013/0182141 A1
(43) Pub. Date: Jul. 18, 2013

(54) ELECTRONIC CAMERA

(71) Applicant: Sanyo Electric Co., Ltd., Moriguchi-shi (JP)

(72) Inventor: Takahiro Hori, Shijonawate-shi (JP)

(73) Assignee: SANYO ELECTRIC CO., LTD., Moriguchi-shi (JP)

(21) Appl. No.: 13/737,569

(22) Filed: Jan. 9, 2013

(30) Foreign Application Priority Data
Jan. 12, 2012 (JP) 2012-004407

(51) Int. Cl. H04N 5/225

(52) U.S. Cl. CPC H04N 5/225
USPC 348/222.1

(57) ABSTRACT

An electronic camera includes an imager. An imager has an imaging surface capturing an optical image representing a scene, and repeatedly outputs an electronic image corresponding to the optical image. A searcher searches for a characteristic image representing a characteristic portion of a specific object from the electronic image outputted from the imager. A detector detects a direction of the specific object based on a distortion of the characteristic image detected by the searcher. An assigner assigns an adjustment area to a position in which an offset inhibiting a difference between the direction detected by the detector and a predetermined direction is appended, by using a position covering the characteristic image detected by the searcher as a reference. An adjuster adjusts an imaging condition based on a partial image belonging to the adjustment area out of the electronic image outputted from the imager.

### CROSS REFERENCE OF RELATED APPLICATION

The disclosure of Japanese Patent Application No. 2012-4407, which was filed on Jan. 12, 2012, is incorporated herein by reference.

### BACKGROUND OF THE INVENTION

1. Field of the Invention

The present invention relates to an electronic camera, and in particular, relates to an electronic camera which adjusts an imaging condition by noticing a specific object appeared in a scene captured on an imaging surface.

2. Description of the Related Art

According to one example of this type of camera, when a face region is detected by a face detecting process for image data acquired by an imaging process, a region moved from the detected face region to a direction of a face orientation is specified as a prediction region. An AE process is executed by using the specified prediction region as a photometry region.

However, in the above-described camera, for example, when the face orientation is alternately changed to right and left, the photometry region is alternately moved right and left with a magnitude exceeding the change. Thus, if a scene where a person standing on a same position is photographed in a still-image mode is assumed, in the above-described camera, an exposure adjusting behavior may become unstable.

### SUMMARY OF THE INVENTION

An electronic camera according to the present invention comprises: an imager, having an imaging surface capturing an optical image representing a scene, which repeatedly outputs an electronic image corresponding to the optical image; a searcher which searches for a characteristic image representing a characteristic portion of a specific object from the electronic image outputted from the imager; a detector which detects a direction of the specific object based on a distortion of the characteristic image detected by the searcher; an assigner which assigns an adjustment area to a position in which an offset inhibiting a difference between the direction detected by the detector and a predetermined direction is appended, by using a position covering the characteristic image detected by the searcher as a reference; and an adjuster which adjusts an imaging condition based on a partial image belonging to the adjustment area out of the electronic image outputted from the imager.

According to the present invention, an imaging control program recorded on a non-transitory recording medium in order to control an electronic camera provided with an imager, having an imaging surface capturing an optical image representing a scene, which repeatedly outputs an electronic image corresponding to the optical image, the program causing a processor of the electronic camera to perform the steps comprises: a searching step of searching for a characteristic image representing a characteristic portion of a specific object from the electronic image outputted from the imager; a detecting step of detecting a direction of the specific object based on a distortion of the characteristic image detected by the searching step; an assigning step of assigning an adjustment area to a position in which an offset inhibiting a difference between the direction detected by the detecting step and a predetermined direction is appended, by using a position covering the characteristic image detected by the searching step as a reference; and an adjusting step of adjusts an imaging condition based on a partial image belonging to the adjustment area out of the electronic image outputted from the imager.

According to the present invention, an imaging control method executed by an electronic camera, comprises: a searching step of searching for a characteristic image representing a characteristic portion of a specific object from the electronic image outputted from the imager; a detecting step of detecting a direction of the specific object based on a distortion of the characteristic image detected by the searching step; an assigning step of assigning an adjustment area to a position in which an offset inhibiting a difference between the direction detected by the detecting step and a predetermined direction is appended, by using a position covering the characteristic image detected by the searching step as a reference; and an adjusting step of adjusts an imaging condition based on a partial image belonging to the adjustment area out of the electronic image outputted from the imager.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of an assignment state of an evaluation area on an imaging surface;

FIG. 4 is an illustrative view showing one example of a dictionary applied to the embodiment in FIG. 2;

FIG. 5(A) is an illustrative view showing one example of an image displayed on an LCD monitor applied to the embodiment in FIG. 2;

FIG. 5(B) is an illustrative view showing one example of an assignment state of an adjustment area on the imaging surface;

FIG. 6(A) is an illustrative view showing another example of the image displayed on the LCD monitor applied to the embodiment in FIG. 2;

FIG. 6(B) is an illustrative view showing another example of an assignment state of the adjustment area on the imaging surface;

FIG. 7(A) is an illustrative view showing still another example of the image displayed on the LCD monitor applied to the embodiment in FIG. 2;

FIG. 7(B) is an illustrative view showing still another example of an assignment state of the adjustment area on the imaging surface;

FIG. 8(A) is an illustrative view showing one example of the image displayed on the LCD monitor applied to the embodiment in FIG. 2;

FIG. 8(B) is an illustrative view showing one example of an assignment state of the adjustment area on the imaging surface;

FIG. 9(A) is an illustrative view showing another example of the image displayed on the LCD monitor applied to the embodiment in FIG. 2;

FIG. 9(B) is an illustrative view showing another example of an assignment state of the adjustment area on the imaging surface;

FIG. 10 is an illustrative view showing one example of an initial assignment state of the adjustment area on the imaging surface;

FIG. 11 is a block diagram showing one example of a configuration of a face detecting circuit applied to the embodiment in FIG. 2;

FIG. 12 is a flowchart showing one portion of behavior of a CPU applied to the embodiment in FIG. 2;

FIG. 13 is a flowchart showing another portion of behavior of the CPU applied to the embodiment in FIG. 2;

FIG. 14 is a flowchart showing still another portion of behavior of the CPU applied to the embodiment in FIG. 2; and

FIG. 15 is a block diagram showing a configuration of another embodiment of the present invention.

### DETAILED DESCRIPTION OF THE PREFERRED EMBODIMENTS

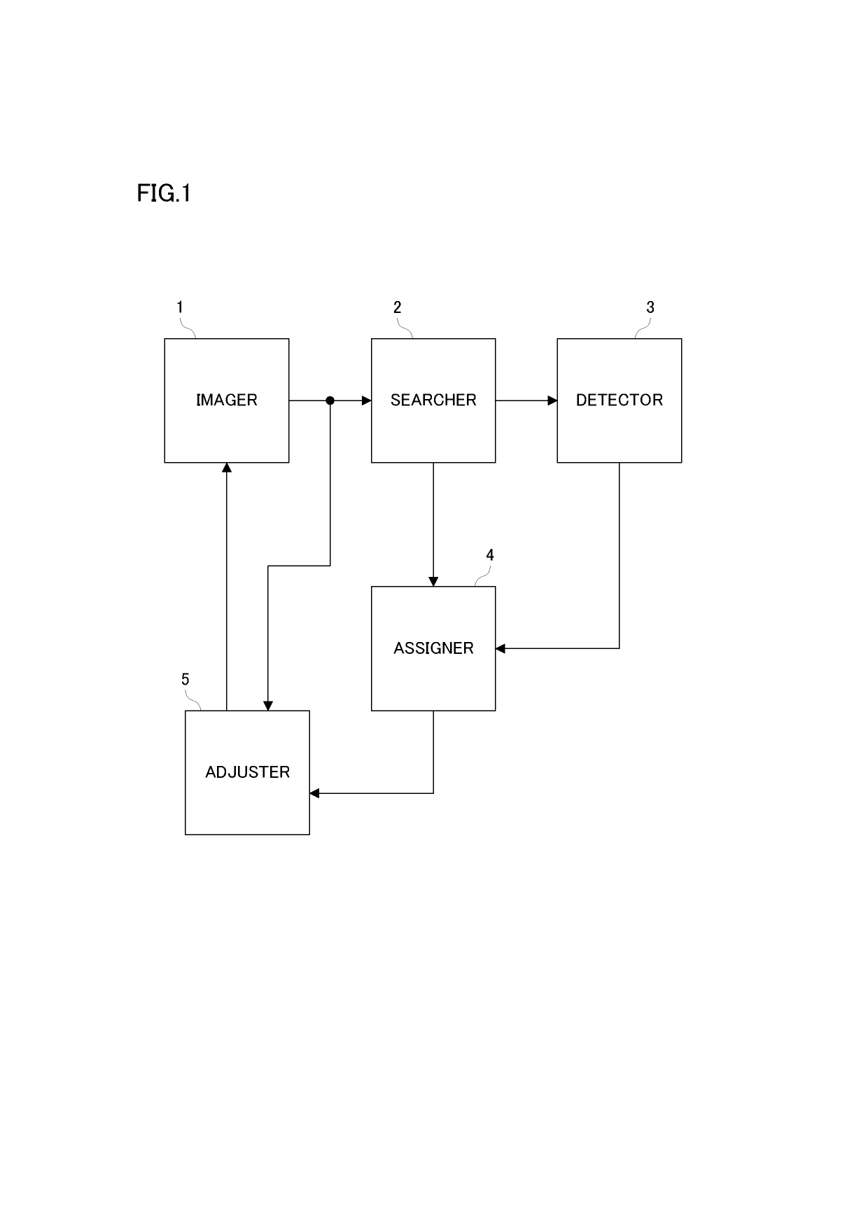

With reference to FIG. 1, an electronic camera according to one embodiment of the present invention is basically configured as follows: An imager 1 has an imaging surface capturing an optical image representing a scene, and repeatedly outputs an electronic image corresponding to the optical image. A searcher 2 searches for a characteristic image representing a characteristic portion of a specific object from the electronic image outputted from the imager 1. A detector 3 detects a direction of the specific object based on a distortion of the characteristic image detected by the searcher 2. An assigner 4 assigns an adjustment area to a position in which an offset inhibiting a difference between the direction detected by the detector 2 and a predetermined direction is appended, by using a position covering the characteristic image detected by the searcher 2 as a reference. An adjuster 5 adjusts an imaging condition based on a partial image belonging to the adjustment area out of the electronic image outputted from the imager 1.

Thus, when the characteristic image representing the characteristic portion of the specific object is detected, the direction of the specific object is detected based on the detected characteristic image. The adjustment area for adjusting the imaging condition is assigned to the position in which the offset inhibiting the difference between the direction of the specific object and the predetermined direction is appended, by using the position covering the detected characteristic image as the reference. Thereby, a behavior of adjusting the imaging condition becomes stable, and it is possible to improve a performance of adjusting the imaging condition.

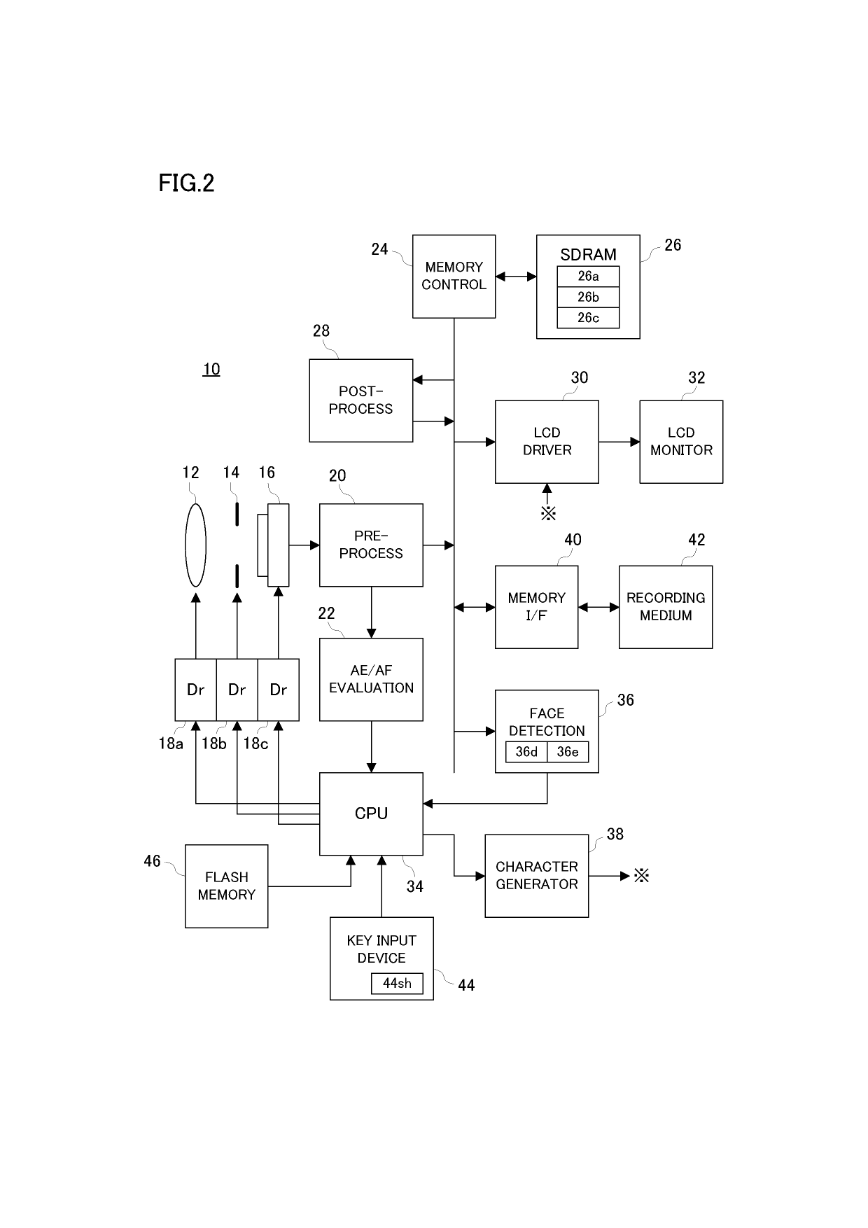

With reference to FIG. 2, a digital camera 10 according to one embodiment includes a focus lens 12 and an aperture unit 14 driven by drivers 18a to 18b, respectively. An optical image that underwent these components enters, with irradiation, an imaging surface of an imager 16, and is subjected to a photoelectric conversion. Thereby, generated are electric charges corresponding to the optical image.

When a power source is applied, in order to execute a moving-image taking process under an imaging task, a CPU 34 commands a driver 18c to repeat an exposure procedure and an electric-charge reading-out procedure. In response to a vertical synchronization signal Vsync periodically generated from an SG (Signal Generator) not shown, the driver 18c exposes the imaging surface and reads out the electric charges produced on the imaging surface in a raster scanning manner. From the imager 16, raw image data that is based on the read-out electric charges is cyclically outputted.

A pre-processing circuit 20 performs processes, such as digital clamp, pixel defect correction, gain control and etc., on the raw image data outputted from the imager 16. The raw image data on which these processes are performed is written into a raw image area 26a of an SDRAM 26 through a memory control circuit 24.

A post-processing circuit 28 reads out the raw image data stored in the raw image area 26a through the memory control circuit 24, and performs a color separation process, a white balance adjusting process and a YUV converting process, on the read-out raw image data. The YUV formatted image data produced thereby is written into a YUV image area 26b of the SDRAM 26 by the memory control circuit 24.

An LCD driver 30 repeatedly reads out the image data stored in the YUV image area 26b through the memory control circuit 24, and drives an LCD monitor 32 based on the read-out image data. As a result, a real-time moving image (a live view image) representing the scene captured on the imaging surface is displayed on a monitor screen.

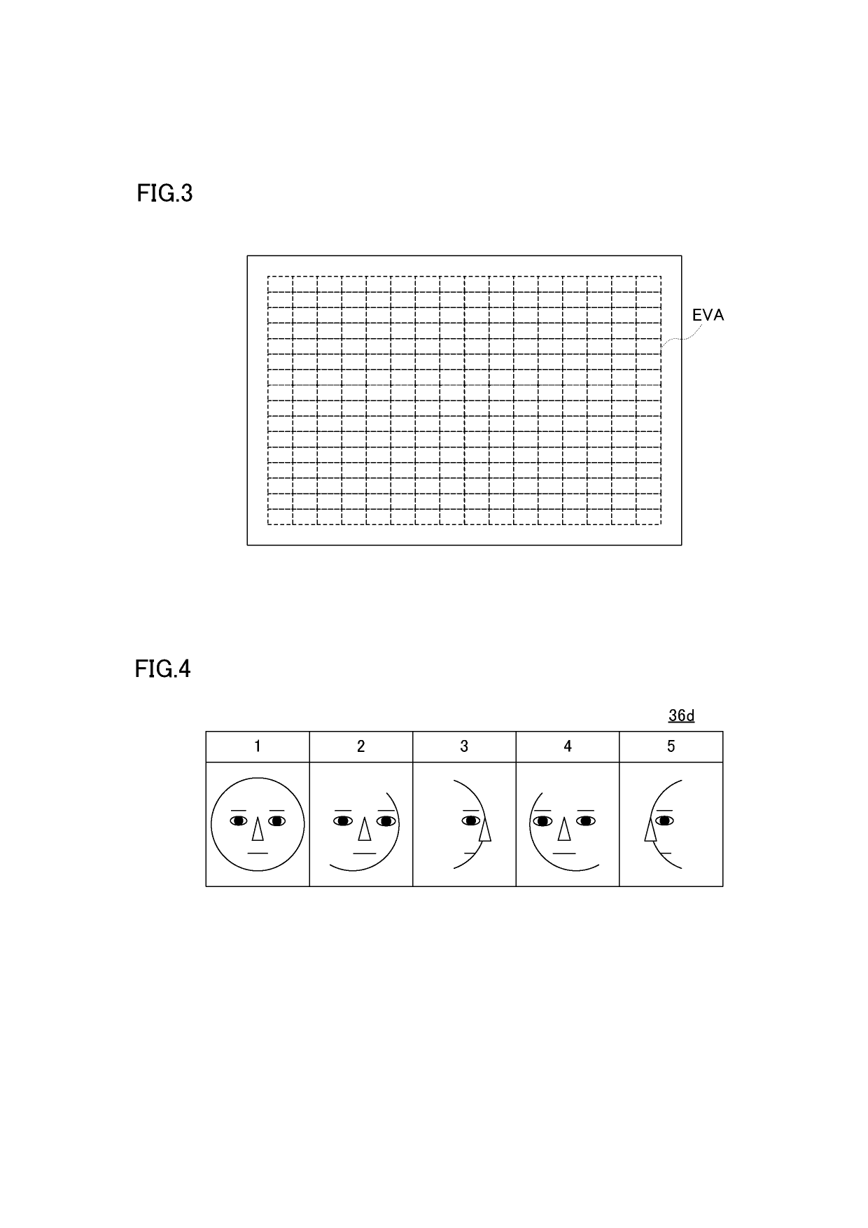

With reference to FIG. 3, an evaluation area EVA is assigned to the imaging surface. The evaluation area EVA is divided into 16 portions in each of a horizontal direction and a vertical direction; therefore, the evaluation area EVA is formed of 256 divided areas. Moreover, in addition to the above-described processes, the pre-processing circuit 20 shown in FIG. 2 executes a simple Y converting process which simply converts the raw image data into Y data.

An AE/AF evaluating circuit 22 integrates Y data belonging to the evaluation area EVA, out of the Y data produced by the pre-processing circuit 20, at every time the vertical synchronization signal Vsync is generated. Thereby, 256 integral values (256 AE evaluation values) are outputted from the AE/AF evaluating circuit 34 in response to the vertical synchronization signal Vsync.

Moreover, the AE/AF evaluating circuit 22 integrates a high-frequency component of the Y data belonging to the evaluation area EVA, out of the Y data generated by the pre-processing circuit 22, at every time the vertical synchronization signal Vsync is generated. Thereby, 256 integral values (256 AF evaluation values) are outputted from the AE/AF evaluating circuit 22 in response to the vertical synchronization signal Vsync.

Moreover, under an imaging assisting task parallel with the imaging task, the CPU 34 repeatedly executes a face searching process. Upon the face searching process, a searching request is issued toward a face detecting circuit 36 at every time the vertical synchronization signal Vsync is generated, for example, ten times.

The face detecting circuit 36 which has accepted the searching request moves a comparing frame structure placed on image data on the YUV image area 26b in a raster scanning manner from a head position to a tail end position, via an initialization of a register 36e, and compares a characteristic amount of partial image data belonging to the comparing frame structure with a characteristic amount of each of five face images registered in a dictionary 36d as shown in FIG. 4.

With reference to FIG. 4, each of the five face images registered in the dictionary 36d has a distortion different depending on an orientation of a face portion. A face image to which an identification number “1” is assigned represents a face portion oriented to a front (=a direction exactly facing the imaging surface), a face image to which an identification number “2” is assigned represents a face portion oriented diagonally forward left, a face image to which an identification number “3” is assigned represents a face portion oriented to a left, a face image to which an identification number “4” is assigned represents a face portion oriented diagonally forward right, and a face image to which an identification number “5” is acquired represents a face portion oriented to a right.

When image data coincident with any one of these face images is detected, the face detecting circuit 36 registers a size and a position of the comparing frame structure at a current time point and the identification number of the subject face image, on the register 36e, and sends back a searching end notification to the CPU 34.

As long as the image data coincident with any of the face images registered in the dictionary 36d is not detected, the comparing frame structure is reduced at every time reaching the tail end position, and is set again to the head position thereafter. Thereby, comparing frame structures having mutually different sizes are scanned on the image data in a raster direction. The searching end notification is also sent back toward the CPU 34 when a comparing frame structure of a minimum size has reached the tail end position.

In response to the searching end notification sent back from the face detecting circuit 36, the CPU 34 determines whether or not a face image of a person has been detected. When there is any registration in the register 36e, it is determined that the face image has been detected. In contrary, when there is no registration in the register 36e, it is determined that the face image has not been detected.

When the face image is detected, the CPU 34 detects an orientation of a face portion corresponding to the identification number registered in the register 36e, i.e., the detected face image, and sets a correction value and a correction direction in a manner different depending on the detected orientation of the face portion.

When the orientation of the face portion is the front (=when the identification number is “1”), the correction value is set to “0”, and the correction direction is set to “indeterminate”. In contrary, when the orientation of the face portion is different from the front (=when the identification number is different from “1”), a value equivalent to a magnitude of a deviation between the orientation of the face portion and the front is set as the correction value, and a direction in which the deviation between the orientation of the face portion and the front is inhibited is set as the correction direction.

Subsequently, the CPU 34 adjusts a position of a face-frame-structure character FK based on the position registered in the register 36e and the correction value and correction direction set in a manner described above. Furthermore, the CPU 34 adjusts a size of the face-frame-structure character FK to a size equivalent to the size registered in the register 36e.

Thus, the face-frame-structure character FK having a size surrounding the face image is placed at a position in which the offset inhibiting the difference between the orientation of the detected face portion and the front is appended, by using the position registered in the register 36e as the reference. When the detected face is oriented to the right as viewed from an operator of the digital camera 10, the placement of the face-frame-structure character FK is corrected to the left. In contrary, when the detected face is oriented to the left as viewed from the operator of the digital camera 10, the placement of the face-frame-structure character FK is corrected to the right.

Thereafter, the CPU 34 issues a face-frame-structure character display command toward a character generator 38. The position and size registered in a manner described above are described in the face-frame-structure character display command. The character generator 38 creates character data of the face-frame-structure character FK with reference to a description of the face-frame-structure character display command, and applies the created character data to the LCD driver 30. The LCD driver 30 drives the LCD monitor 32 based on the applied character data, and as a result, the face-frame-structure character FK is displayed on the LCD monitor 32 in an OSD manner.

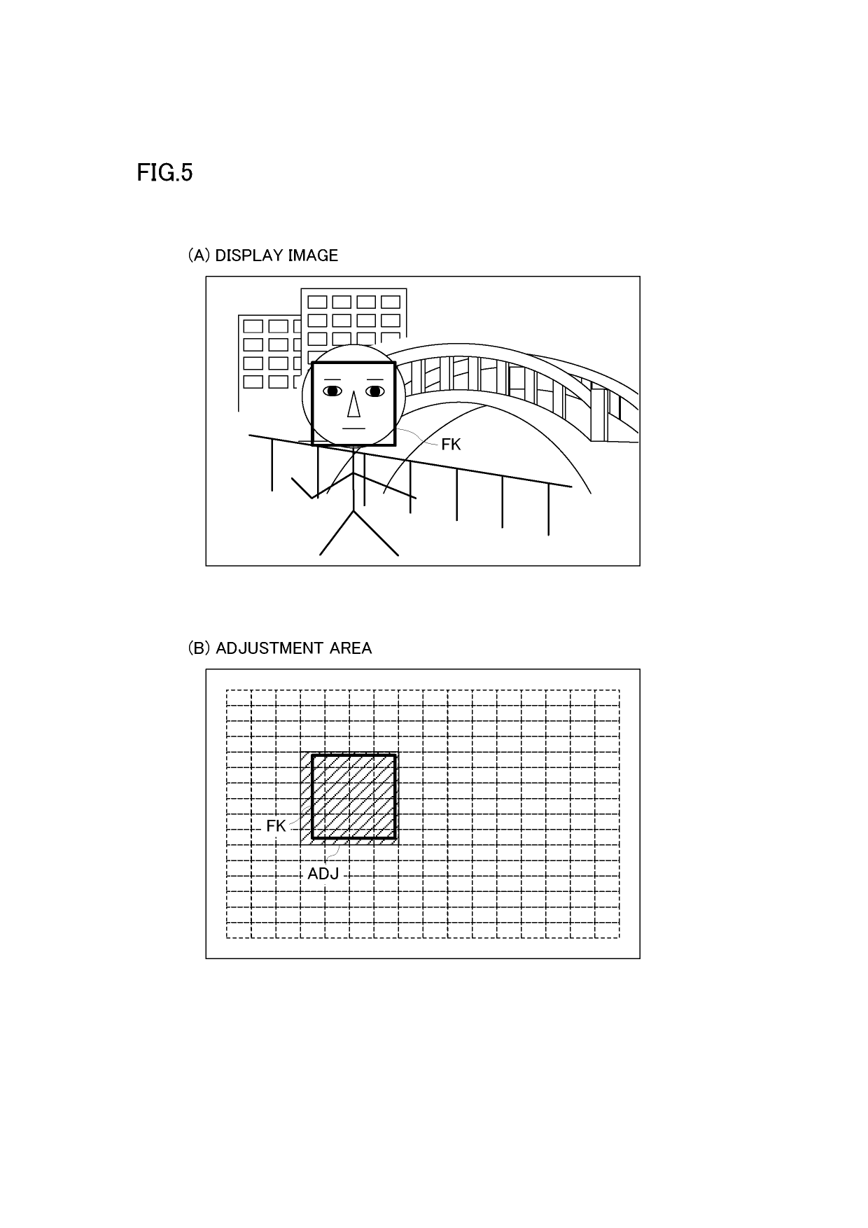

When a live view image is displayed on the LCD monitor 32 as shown in FIG. 5(A), the face portion of the person is oriented to the front, and therefore, the correction value and the correction direction are respectively set to “0” and “indeterminate”. As a result, the face-frame-structure character FK is displayed at a position surrounding the face image of the person.

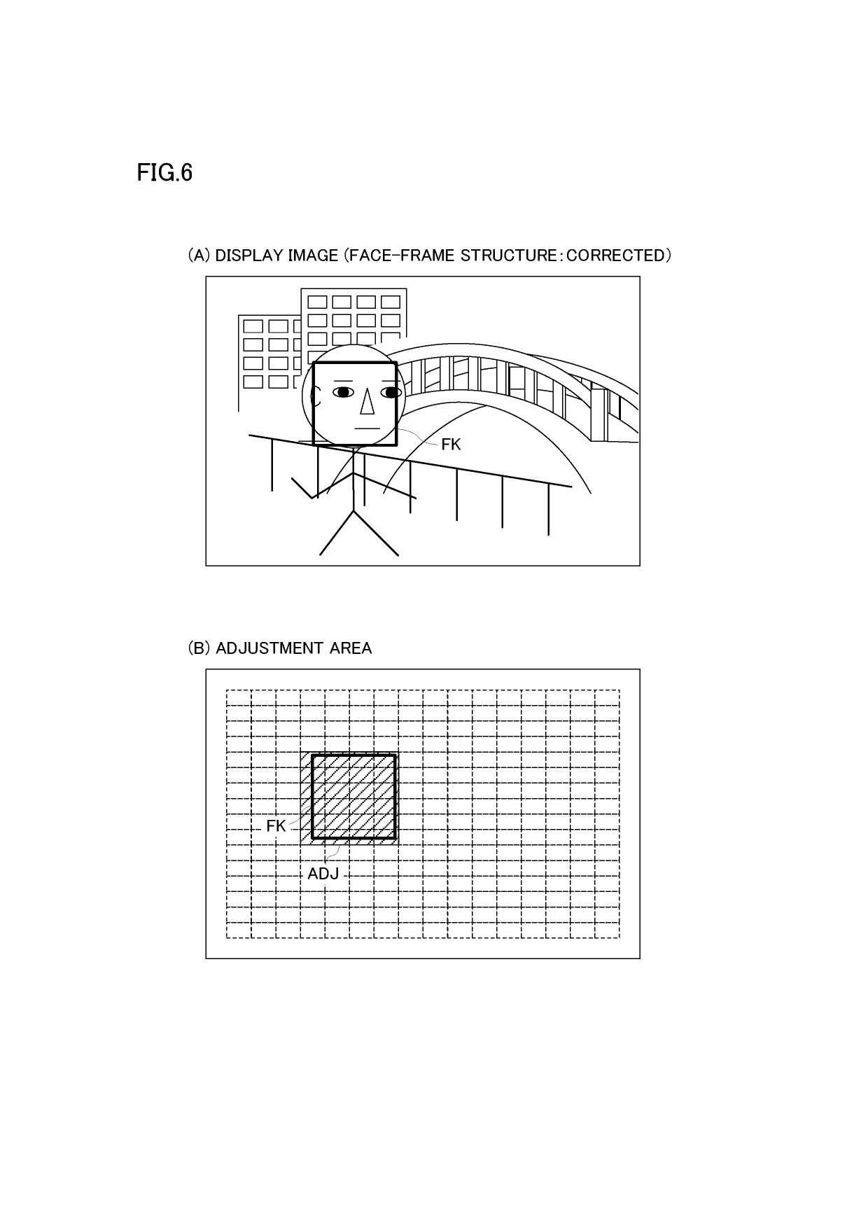

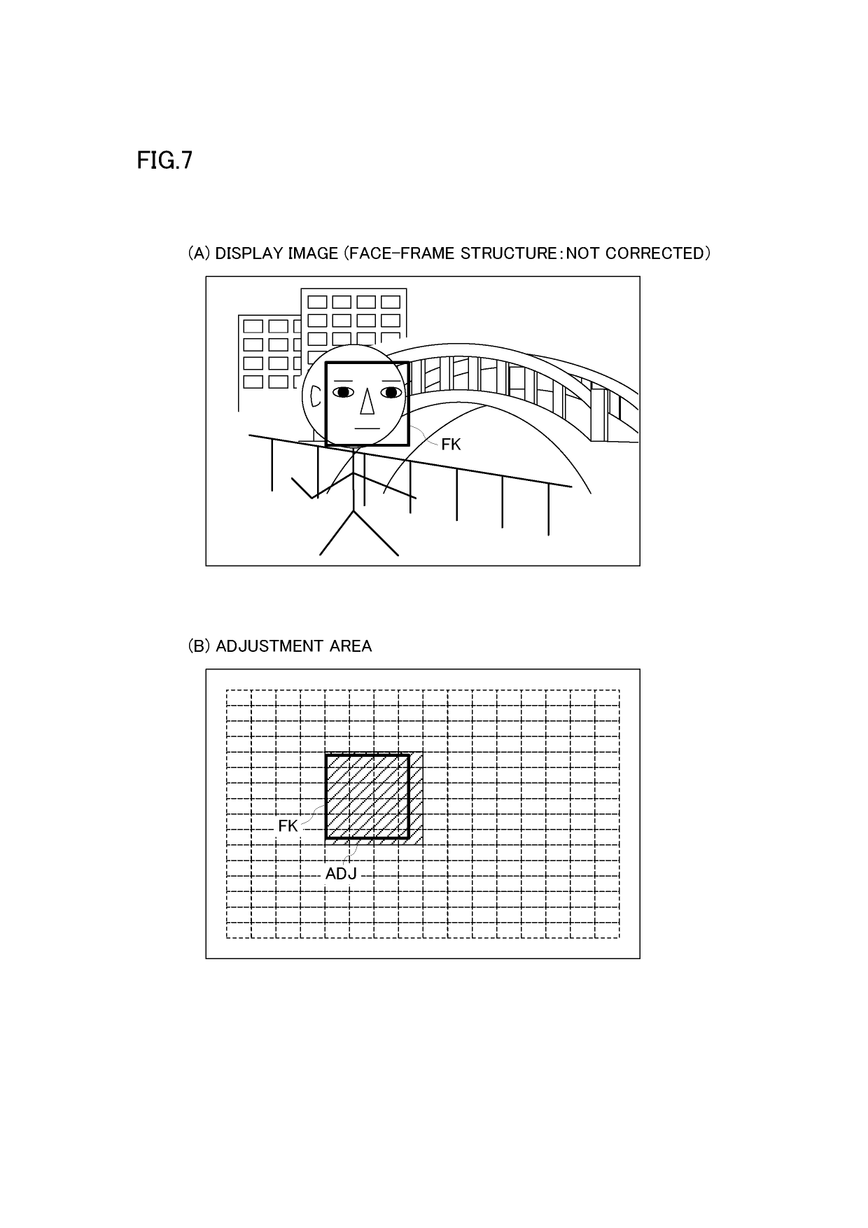

When the live view image is displayed on the LCD monitor 32 as shown in FIG. 6(A), the face portion of the person is oriented to diagonally forward left toward the imaging surface, and therefore, the face-frame-structure character FK is displayed on a right side of a position surrounding the face image of the person. It is noted that, when a display position of the face-frame-structure character FK is not corrected, the face-frame-structure character FK is displayed as shown in FIG. 7(A). The correction value and the correction direction are equivalent to a difference between the display position of the face-frame-structure character FK shown in FIG. 6(A) and the display position of the face-frame-structure character FK shown in FIG. 7(A).

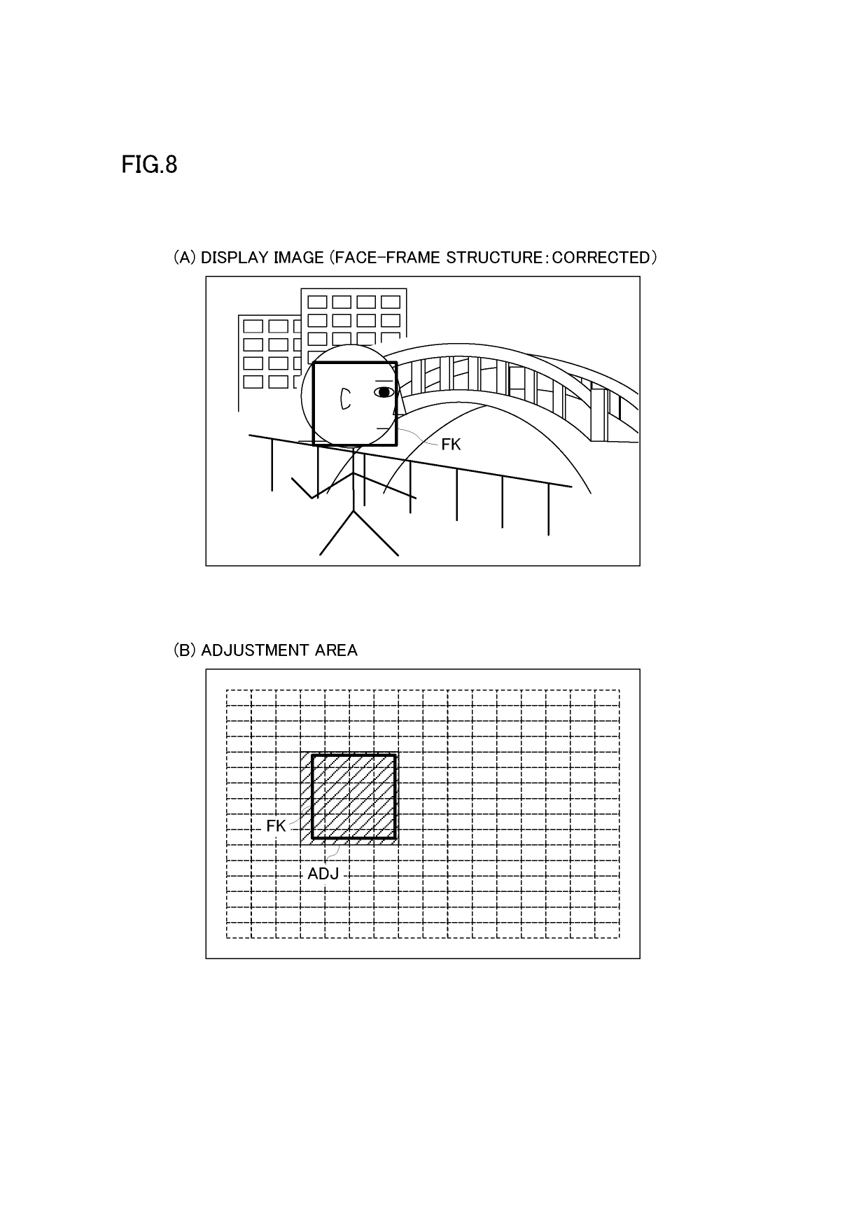

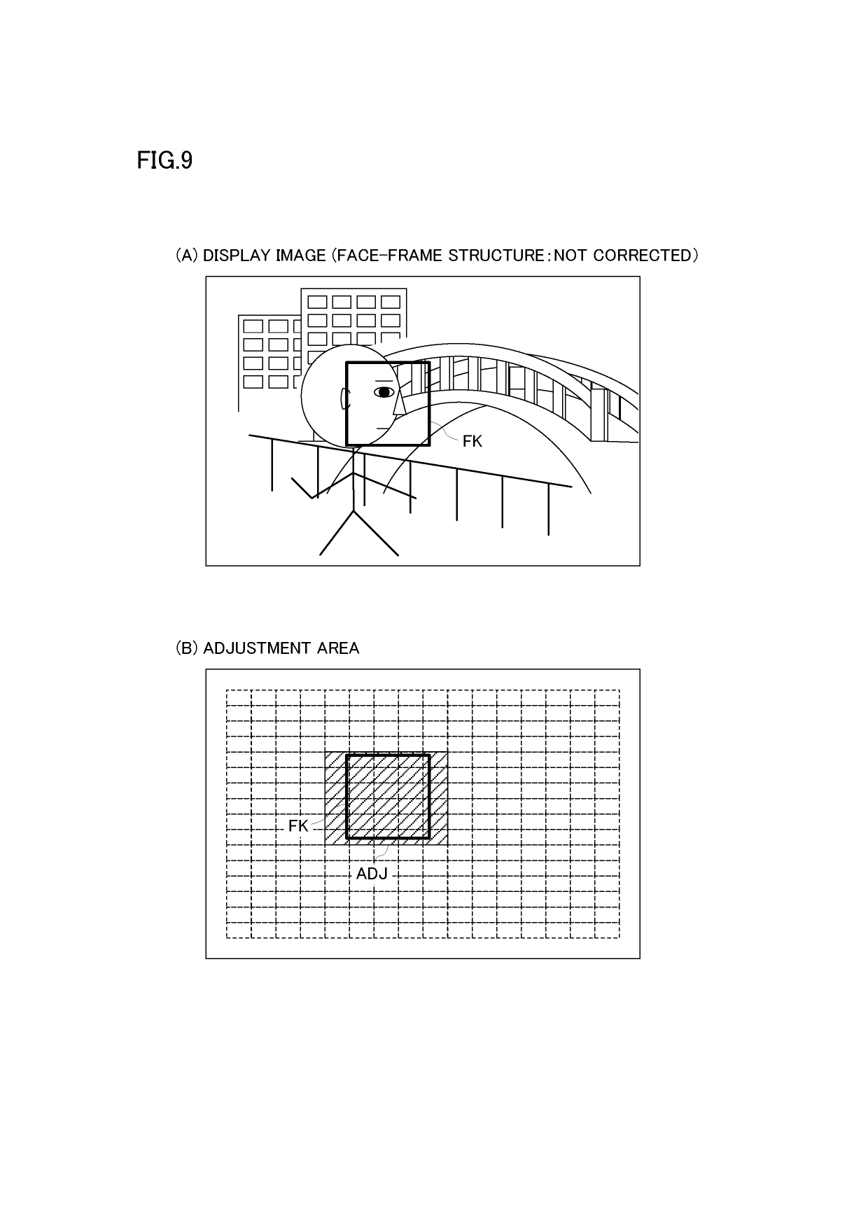

When the live view image is displayed on the LCD monitor 32 as shown in FIG. 8(A), the face portion of the person is oriented to the left toward the imaging surface, and therefore, the face-frame-structure character FK is displayed on the right side of a position surrounding the face image of the person. It is noted that, when the display position of the face-frame-structure character FK is not corrected, the face-frame-structure character FK is displayed as shown in FIG. 9(A). The correction value and the correction direction are equivalent to a difference between the display position of the face-frame-structure character FK shown in FIG. 8(A) and the display position of the face-frame-structure character FK shown in FIG. 9(A).

Moreover, the CPU 34 sets partial divided areas covering the face-frame-structure character FK out of the 256 divided areas forming the evaluation area EVA, as an adjustment area ADJ. The adjustment area ADJ is set as follows: as shown in FIG. 5(B), corresponding to the face-frame-structure character FK displayed as shown in FIG. 5(A); as shown in FIG. 6(B), corresponding to the face-frame-structure character FK displayed as shown in FIG. 6(A); and as shown in FIG. 8(B), corresponding to the face-frame-structure character FK displayed as shown in FIG. 8(A).

For reference, when the face-frame-structure character FK is placed as shown in FIG. 7(A), the adjustment area ADJ is set as shown in FIG. 7(B). Moreover, when the face-frame-structure character FK is placed as shown in FIG. 9(A), the adjustment area ADJ is set as shown in FIG. 9(B).

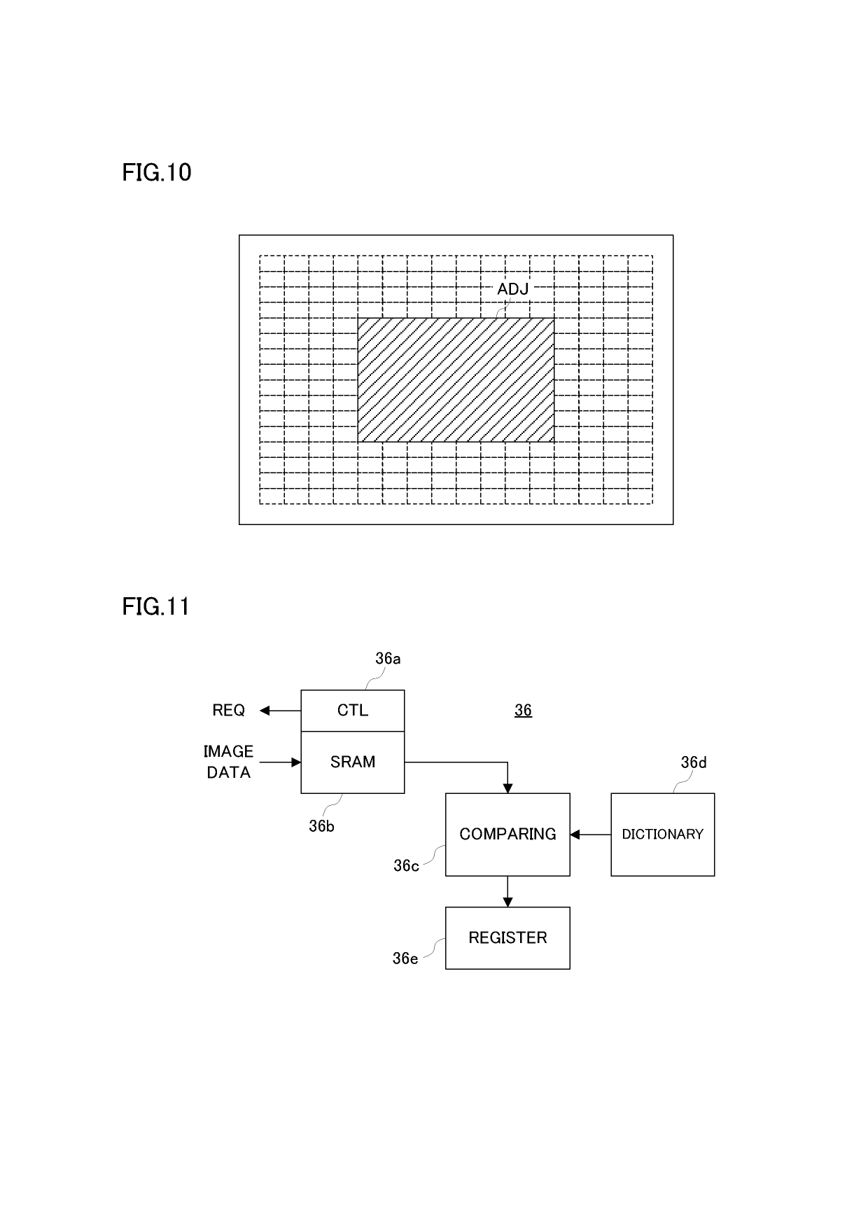

It is noted that, when the face image is not detected, the face-frame-structure character FK is hidden, and the adjustment area ADJ is placed at an initial position. As shown in FIG. 10, the adjustment area ADJ has a size equivalent to an eight-by-eight divided areas and is assigned to a center of the imaging surface.

Returning to the imaging task, when a shutter button 44sh is in a non-operated state, the CPU 34 extracts, from among the 256 AE evaluation values outputted from the AE/AF evaluating circuit 22, partial AE evaluation values belonging to the adjustment area ADJ defined in a manner described above, and executes a simple AE process based on the extracted AE evaluation values. An aperture amount and an exposure time period defining an appropriate EV value calculated thereby are respectively set to the drivers 18b and 18c. Thereby, a brightness of the live view image is roughly adjusted by using a partial image belonging to the adjustment area ADJ as a reference.

Moreover, the CPU 34 executes a simple AF process (=a continuous AF) based on partial AF evaluation values belonging to the adjustment area ADJ out of the 256 AF evaluation values outputted from the AE/AF evaluating circuit 22. In order to track a focal point, the focus lens 12 is moved in an optical-axis direction by the driver 18a. As a result, a sharpness of the live view image is roughly adjusted by using the partial image belonging to the adjustment area ADJ as a reference.

When the shutter button 44sh is half depressed, the CPU 34 executes a strict AE process referring to the partial AE evaluation values belonging to the adjustment area ADJ so as to calculate an optimal EV value. An aperture amount and an exposure time period defining the calculated optimal EV value also are respectively set to the drivers 18b and 18c, and thereby, a brightness of the live view image is adjusted strictly.

Moreover, the CPU 34 executes a strict AF process based on the partial AF evaluation values belonging to the adjustment area ADJ. The focus lens 12 is moved in the optical-axis direction by the driver 18a in order to search a focal point, and is placed at the focal point discovered thereby. As a result, a sharpness of the live view image is adjusted strictly.

When the shutter button 44sh is fully depressed, the CPU 34 personally executes a still-image taking process, and commands a memory I/F 40 to execute a recording process. One frame of image data representing a scene at a time point when the shutter button 44sh is fully depressed is evacuated from the YUV image area 26b to a still image area 26c by the still-image taking process. The memory I/F 40 commanded to execute the recording process reads out one frame of the image data evacuated to the still image area 26c through the memory control circuit 24, and records the read-out image data on a recording medium 42 in a file format.

The face detecting circuit 36 is configured as shown in FIG. 11. A controller 36a assigns a rectangular comparing frame structure to the YUV image area 26b of the SDRAM 26, and reads out partial image data belonging to the comparing frame structure through the memory control circuit 24. The read-out image data is applied to a comparing circuit 36c via an SRAM 36b.

The dictionary 36d contains templates representing the face images of the person. The comparing circuit 36c compares the image data applied from the SRAM 36b with the templates contained in the dictionary 36d. When a template coincident with the image data is discovered, the comparing circuit 36c registers a position and a size of the comparing frame structure at a current time point and the identification number of the subject face image, onto the register 36e.

The comparing frame structure moves by each predetermined amount in a raster scanning manner, from the head position (an upper left position) toward the tail end position (a lower right position) of the SDRAM 24. Moreover, the size of the comparing frame structure is updated at each time the comparing frame structure reaches the tail end position in the order of “large size” to “intermediate size” to “small size”. When a comparing frame structure of “small size” has reached the tail end position, the searching end notification is sent back from the comparing circuit 36c toward the CPU 34.

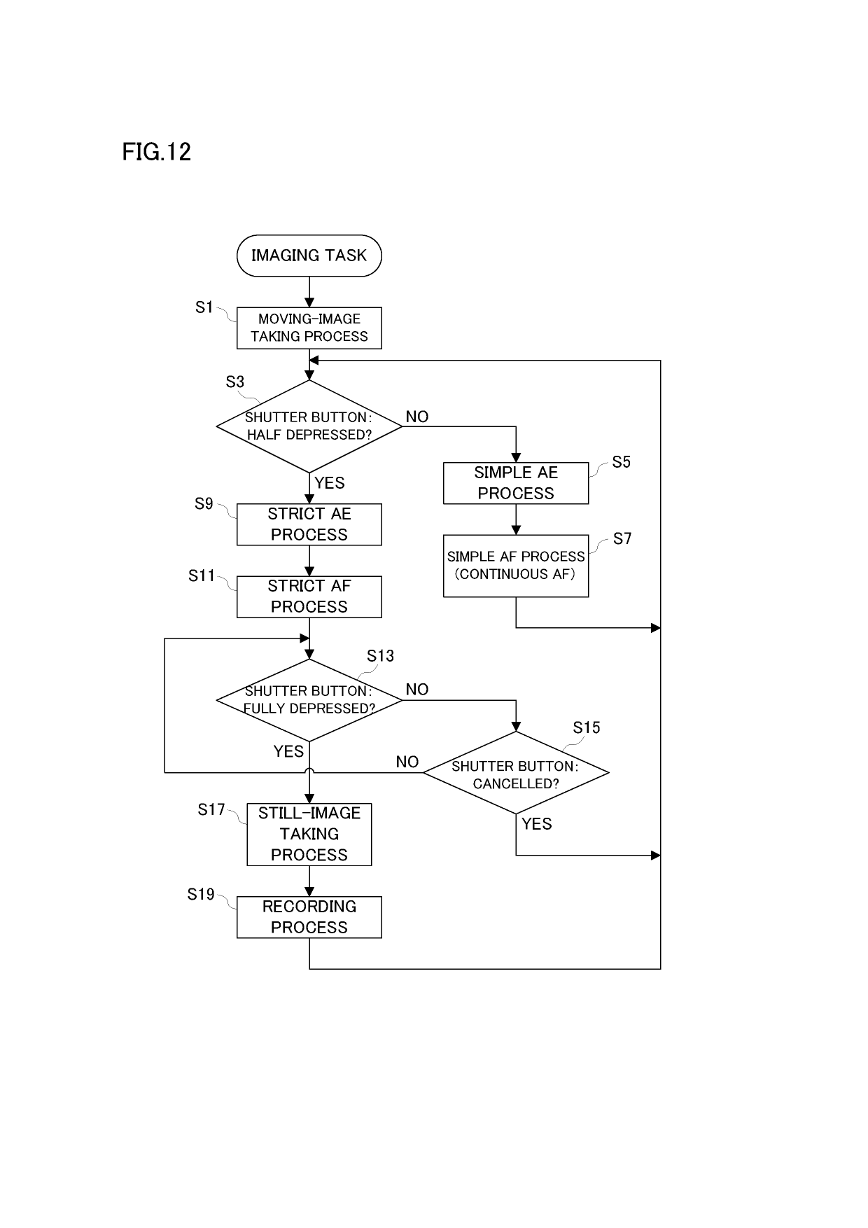

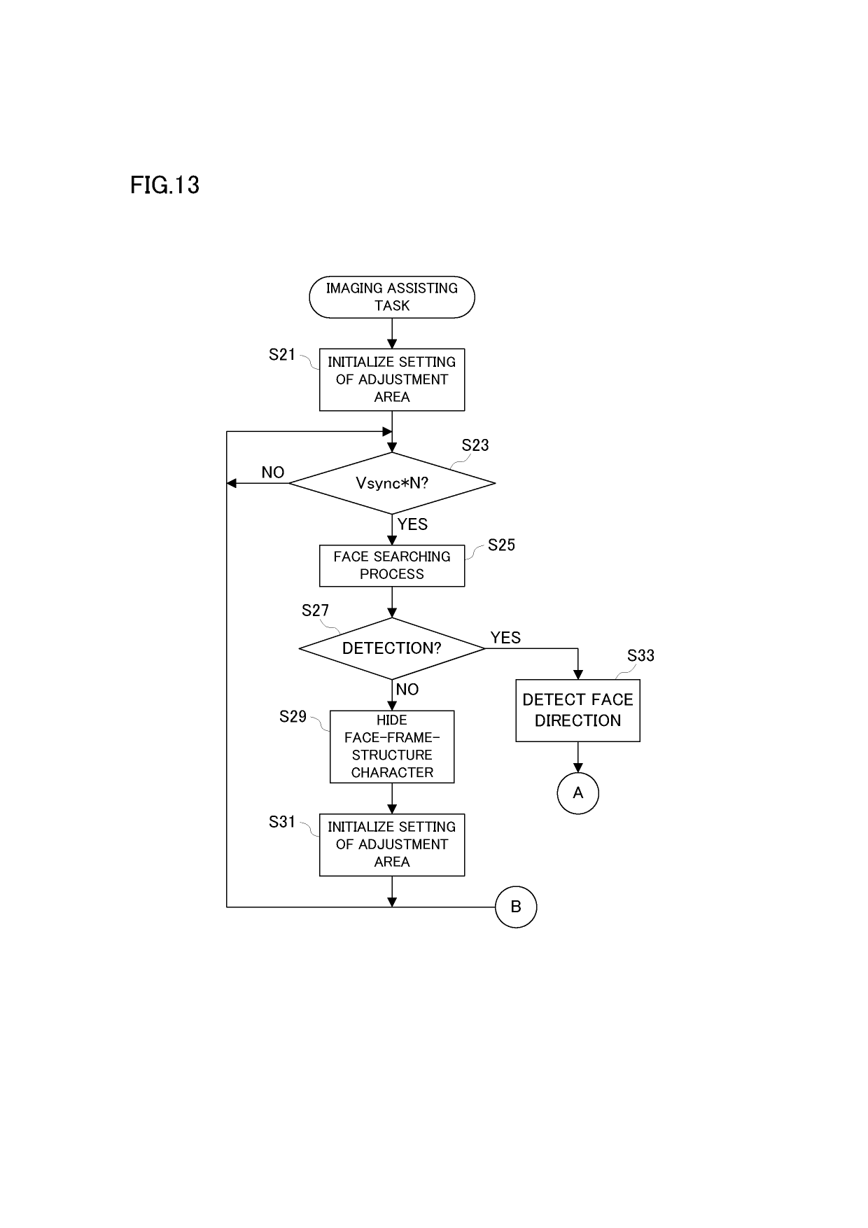

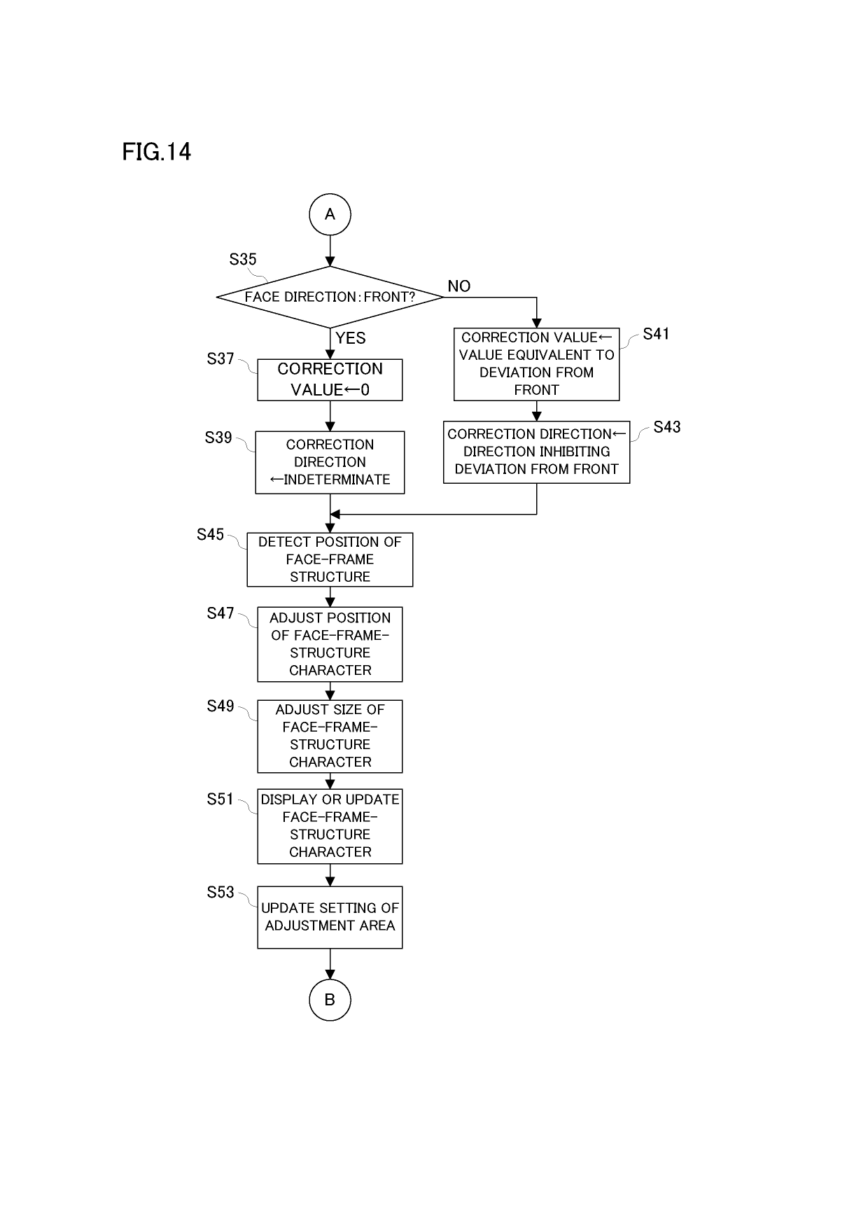

The CPU 34 performs a plurality of tasks including the imaging task shown in FIG. 12 and the imaging assisting task shown in FIG. 13 to FIG. 14, in a parallel manner. It is noted that control programs corresponding to these tasks are stored in a flash memory 46.

With reference to FIG. 12, in a step S1, the moving-image taking process is executed. As a result, a live view image representing a scene captured on the imaging surface is displayed on the LCD monitor 32. In a step S3, it is determined whether or not the shutter button 44sh is half-depressed, and when a determined result is NO, the simple AE process and the simple AF process are respectively executed in steps S5 and S7. As a result, a brightness and a sharpness of the live view image are adjusted roughly.

When the determined result of the step S3 is updated from NO to YES, the strict AE process is executed in a step S9, and the strict AF process is executed in a step S11. A brightness of the live view image is strictly adjusted by the strict AE process, and a sharpness of the live view image is strictly adjusted by the strict AF process.

In a step S13, it is determined whether or not the shutter button 46sh is fully depressed, and in a step S15, it is determined whether or not an operation of the shutter button 44sh is cancelled. When a determined result of the step S15 is YES, the process directly returns to the step S3, and when a determined result of the step S13 is YES, the process returns to the step S3 via processes in steps S17 to S19.

In the step S17, the still-image taking process is executed. As a result, one frame of the image data representing a scene at a time point when the shutter button 44sh is fully depressed is evacuated from the YUV image area 26b to the still image area 26c. In the step S19, the memory I/F 40 is commanded to execute the recording process. The memory I/F 40 reads out one frame of the image data stored in the still image area 26c through the memory control circuit 24, and records the read-out image data on the recording medium 42 in a file format.

With reference to FIG. 13, in a step S21, a setting of the adjustment area ADJ is initialized. The adjustment area ADJ has a size equivalent to the eight-by-eight divided areas and is assigned to a center of the imaging surface. In a step S23, it is determined whether or not the vertical synchronization signal Vsync is generated N times (N: 10, for example). When a determined result is updated from NO to YES, the process advances to a step S25 so as to issue a searching request for the face searching process toward the face detecting circuit 36.

The face detecting circuit 36 moves a comparing frame structure placed on image data on the YUV image area 26b in a raster scanning manner from a head position to a tail end position, via an initialization of the register 36e, and compares a characteristic amount of partial image data belonging to the comparing frame structure with a characteristic amount of each of five face images registered in the dictionary 36d. When image data coincident with the face image registered in the dictionary 36d is detected, the face detecting circuit 36 registers a size and a position of the comparing frame structure at a current time point and the identification number of the subject face image, onto the register 36e. When registering to the register 36e is executed, or when a comparing frame structure of a minimum size has reached the tail end position, the face detecting circuit 36 sends back the searching end notification toward the CPU 34.

When the searching end notification is sent back from the face detecting circuit 36, it is determined whether or not the face image has been detected. When there is no registration in the register 36e, it is determined that the face image has not been detected, and the process advances to a step S29. In contrary, when there is any registration in the register 36e, it is determined that the face image has been detected, and the process advances to a step S33.

In the step S29, the character generator 38 is commanded to hide the face-frame-structure character FK, and in a step S31, the setting of the adjustment area ADJ is initialized. As a result of the process in the step S29, the face-frame-structure character FK disappears from the monitor screen. Moreover, as a result of the process in the step S31, the adjustment area ADJ has a size equivalent to the eight-by-eight divided areas and is assigned to a center of the imaging surface. Upon completion of the process in the step S31, the process returns to the step S23.

In the step S33, detected is an orientation of the face portion equivalent to the identification number registered in the register 36e, i.e., the detected face image, and in a step S35, it is determined whether or not the orientation of the detected face portion is the front (=whether or not the identification number is “1”). When a determined result is YES, the process advances to a step S37, and when the determined result is NO, the process advances to a step S41.

In the step S37, the correction value is set to “0”, and in a step S39, the correction direction is set to “indeterminate”. In the step S41, a value equivalent to a magnitude of a deviation between the detected orientation of the face portion and the front is set as the correction value, and in a step S43, a direction in which the deviation between the orientation of the face portion and the front is inhibited is set as the correction direction.

Upon completion of the process in the step S39 or S43, the position registered in the register 36e is detected in a step S45. In a step s47, a position of a face-frame-structure character FK is adjusted based on the position detected in the step S45 and the correction value and correction direction set in the steps S37 to S39 or S41 to S43. In a step S49, a size of the face-frame-structure character FK is adjusted to a size equivalent to the size registered in the register 36e.

Thus, the face-frame-structure character FK having a size surrounding the face image is placed at a position in which the offset inhibiting the difference between the orientation of the face detected in the step S33 and the front is appended, by using the position detected in the step S45 as the reference.

In a step S51, the face-frame-structure character display command is issued toward the character generator 38. The position and size adjusted in the steps S47 to S49 are described in the issued face-frame-structure character display command. The character generator 38 creates character data of the face-frame-structure character FK with reference to a description of the face-frame-structure character display command, and applies the created character data to the LCD driver 30. The LCD driver 30 drives the LCD monitor 32 based on the applied character data, and as a result, the face-frame-structure character FK is displayed (or updated) on the LCD monitor 32 in an OSD manner.

In a step S53, partial divided areas covering the face-frame-structure character FK thus displayed is set as the adjustment area ADJ. Thus, as long as the face image is detected, the placement of the adjustment area ADJ is updated in a manner to track the detected face image. Upon completion of the setting, the process returns to the step S23.

As can be seen from the above-described explanation, the imager 16 has the imaging surface capturing the optical image representing the scene, and repeatedly outputs the electronic image corresponding to the optical image. The CPU 34 searches for the face image representing the face portion of the person from the YUV formatted image data that is based on the raw image data outputted from the imager 16 (S25), and detects the orientation of the face portion based on the distortion of the detected face image (S33). Moreover, the CPU 34 assigns the adjustment area ADJ to a position in which the offset inhibiting the difference between the orientation of the face portion and the front is appended, by using the position covering the detected face image as a reference (S35 to S49, S53). The imaging conditions such as the exposure amount and the focus are adjusted based on the raw image data belonging to the adjustment area ADJ thus assigned (S5 to S11).

When the face image representing the face portion of the person is detected, the orientation of the face portion is detected based on the detected face image. The adjustment area ADJ for adjusting the imaging condition is assigned to the position in which the offset inhibiting the difference between the orientation of the face portion and the front is appended, by using the position covering the detected face image as the reference. Thereby, a behavior of adjusting the imaging condition becomes stable, and it is possible to improve a performance of adjusting the imaging condition.

It is noted that, in this embodiment, the face portion of the person is searched, however, a searching target may be a face portion of an animal and even an object except the face portion. Moreover, in this embodiment, the exposure amount and the focus are assumed as the imaging condition to be adjusted, however, the white balance may be added thereto.

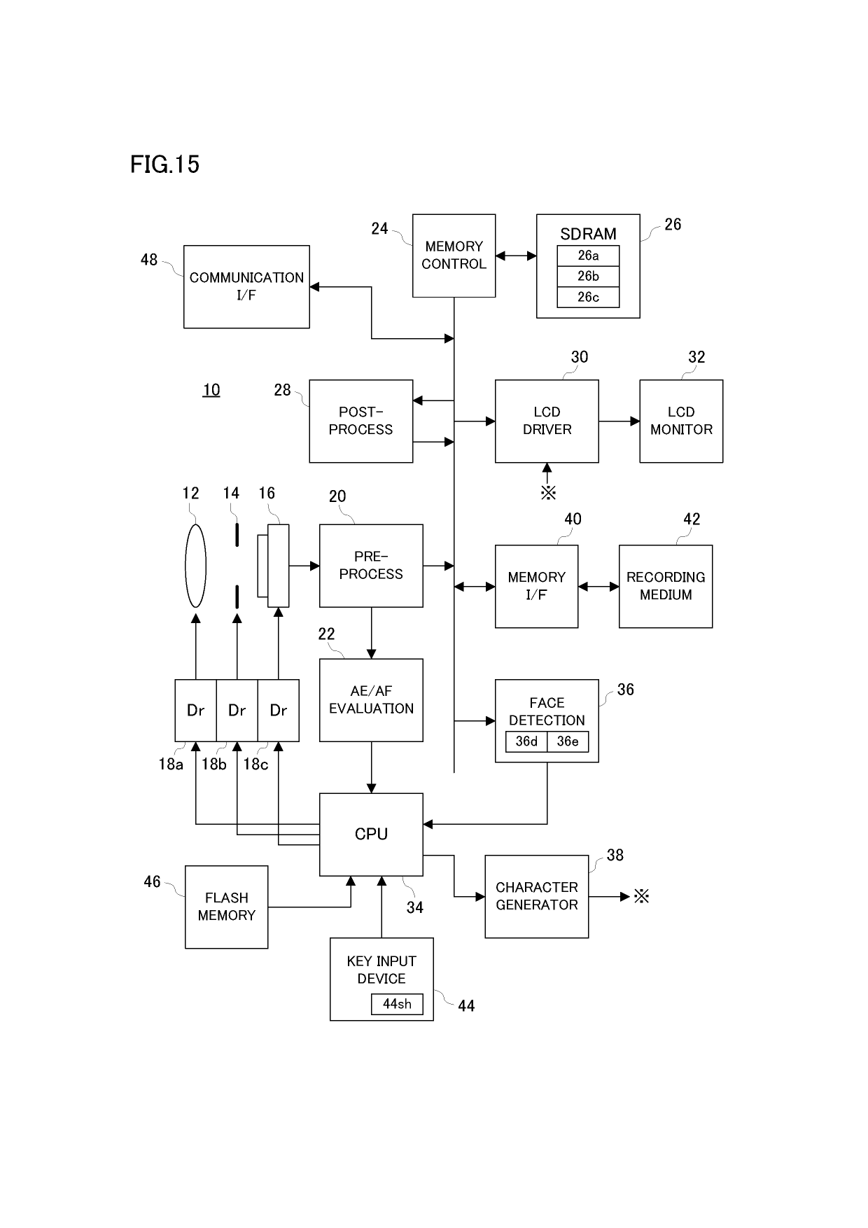

Furthermore, in this embodiment, the control programs equivalent to the multi task operating system and a plurality of tasks executed thereby are previously stored in the flash memory 46. However, a communication I/F 48 may be arranged in the digital camera 10 as shown in FIG. 15 so as to initially prepare a part of the control programs in the flash memory 46 as an internal control program whereas acquire another part of the control programs from an external server as an external control program. In this case, the above-described procedures are realized in cooperation with the internal control program and the external control program.

Moreover, in this embodiment, the processes executed by the CPU 34 are divided into a plurality of tasks in a manner described above. However, these tasks may be further divided into a plurality of small tasks, and furthermore, a part of the divided plurality of small tasks may be integrated into another task. Moreover, when each of tasks is divided into the plurality of small tasks, the whole task or a part of the task may be acquired from the external server.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An electronic camera, comprising:
an imager, having an imaging surface capturing an optical image representing a scene, which repeatedly outputs an electronic image corresponding to the optical image;
a searcher which searches for a characteristic image representing a characteristic portion of a specific object from the electronic image outputted from said imager;
a detector which detects a direction of the specific object based on a distortion of the characteristic image detected by said searcher;
an assigner which assigns an adjustment area to a position in which an offset inhibiting a difference between the direction detected by said detector and a predetermined direction is appended, by using a position covering the characteristic image detected by said searcher as a reference; and
an adjuster which adjusts an imaging condition based on a partial image belonging to the adjustment area out of the electronic image outputted from said imager.

2. An electronic camera according to claim 1, wherein said searcher executes a searching process with reference to a plurality of dictionary images respectively corresponding to a plurality of directions possibly taken by the specific object, and said detector executes a detecting process based on a search result of said searcher.

3. An electronic camera according to claim 1, wherein the predetermined direction is equivalent to a direction of exactly facing said imaging surface.

4. An electronic camera according to claim 1, wherein the imaging condition noticed by said adjuster includes at least one of an exposure amount, a focus and a white balance.

5. An electronic camera according to claim 1, further comprising a setter which sets the adjustment area to a predetermined placement, corresponding to non-detection of said searcher.

6. An imaging control program recorded on a non-transitory recording medium in order to control an electronic camera provided with an imager, having an imaging surface capturing an optical image representing a scene, which repeatedly outputs an electronic image corresponding to the optical image, the program causing a processor of the electronic camera to perform the steps comprising:
a searching step of searching for a characteristic image representing a characteristic portion of a specific object from the electronic image outputted from said imager;
a detecting step of detecting a direction of the specific object based on a distortion of the characteristic image detected by said searching step;
an assigning step of assigning an adjustment area to a position in which an offset inhibiting a difference between the direction detected by said detecting step and a predetermined direction is appended, by using a position covering the characteristic image detected by said searching step as a reference; and
an adjusting step of adjusts an imaging condition based on a partial image belonging to the adjustment area out of the electronic image outputted from said imager.

7. An imaging control method executed by an electronic camera provided with an imager, having an imaging surface capturing an optical image representing a scene, which repeatedly outputs an electronic image corresponding to the optical image, comprising:
a searching step of searching for a characteristic image representing a characteristic portion of a specific object from the electronic image outputted from said imager;
a detecting step of detecting a direction of the specific object based on a distortion of the characteristic image detected by said searching step;
an assigning step of assigning an adjustment area to a position in which an offset inhibiting a difference between the direction detected by said detecting step and a predetermined direction is appended, by using a position covering the characteristic image detected by said searching step as a reference; and
an adjusting step of adjusts an imaging condition based on a partial image belonging to the adjustment area out of the electronic image outputted from said imager.
